(19) United States
(12) Patent Application Publication
(10) Pub. No.: US 2002/0095350 A1
(43) Pub. Date: Jul. 18, 2002

(54) On-demand book purchasing method

(76) Inventor: Akira Taguchi, Yokohama (JP)

Correspondence Address: Robert A. Parsons, PARSONS & GOLTRY, Suite 260, 340 East Palm Lane, Phoenix, AZ, 85004, US

(21) Appl. No.: 09/909,078

(22) Filed: Jul. 19, 2001

(30) Foreign Application Priority Data
Jan. 16, 2001 (JP) 2001-008133

(51) Int. Cl. G06F 17/60

(52) U.S. Cl. 705/26

(57) ABSTRACT

A method for disclosing at least half or more of the content of a book via the Internet and promoting the motivation to buy a book is provided. A book to be viewed is selected (52) from books listed on a book purchase home page (51). A portion (or the whole, in some cases) of the book is disclosed, and the reader selects (54) to purchase a book, and when he decides to purchase the book, he clicks (55) the “Buy” button on the home page. His address, name, and payment method for purchasing the book are inputted (58), and the resulting information is sent to a book printing/binding vendor, where printing and binding of the book is initiated. A completed copy of the book is sent to the buyer by mail or home delivery service.

### CROSS-REFERENCE TO RELATED APPLICATION

This application claims priority to Japanese Patent Application No. 2001-008133, filed Jan. 16, 2001.

### FIELD OF THE INVENTION

The present invention relates generally to methods for printing a book in response to a request from a person who wants to buy the book and delivering the book to that person, and, in particular, to an on-demand book purchasing method including the step of allowing a preview of at least half of the content of a book before the purchase of that book.

### BACKGROUND OF THE INVENTION

Generally, a book is purchased from a bookstore, and it is a common practice to read the book bit by bit to check the content thereof before deciding to buy the book. In other words, it often seems likely that reading books while browsing at the bookstore may result in the motivation to buy books. Recently, there are increasingly numbers of home pages selling various types of articles over the Internet, and some home pages that sell books online have also appeared. On such home pages, titles of the books that may be purchased are displayed in list form, so that a would-be customer selects desired books from the list and wants to purchase them.

However, when purchasing a book from the home page over the Internet, a potential customer often had to make a purchase decision, judging only from the title of the book, or by merely reading reviews of that book or a summary of the content thereof. Such a marketing approach makes it difficult for the potential customer to decide whether the content of the book is desired or not.

### SUMMARY OF THE INVENTION

Therefore, a method according to the present invention, where a book is printed and delivered via a telecommunication line in response to a request from a person who wants to buy the book, comprises selecting a desired book from a book list displayed on a book recommendation home page and displaying a part or whole of the content of the book. The person who wants to buy the book previews the content before deciding to buy the book. When he wants to buy the book selected, he inputs predetermined items required to buy the book. Based on the information inputted, the book selected is printed and bound, and then delivered to him.

### BRIEF DESCRIPTION OF THE DRAWINGS

FIG. 1 shows an overall schematic diagram for implementing the present invention;

FIG. 2 shows an example of a home page where books to be sold are presented in list view;

FIG. 3 shows an example of a screen where the content of a book is displayed;

FIG. 4 shows an example of a page where a purchase procedure is performed; and

FIG. 5 is a flowchart for describing the method according to the present invention.

### DETAILED DESCRIPTION OF THE PREFERRED EMBODIMENT

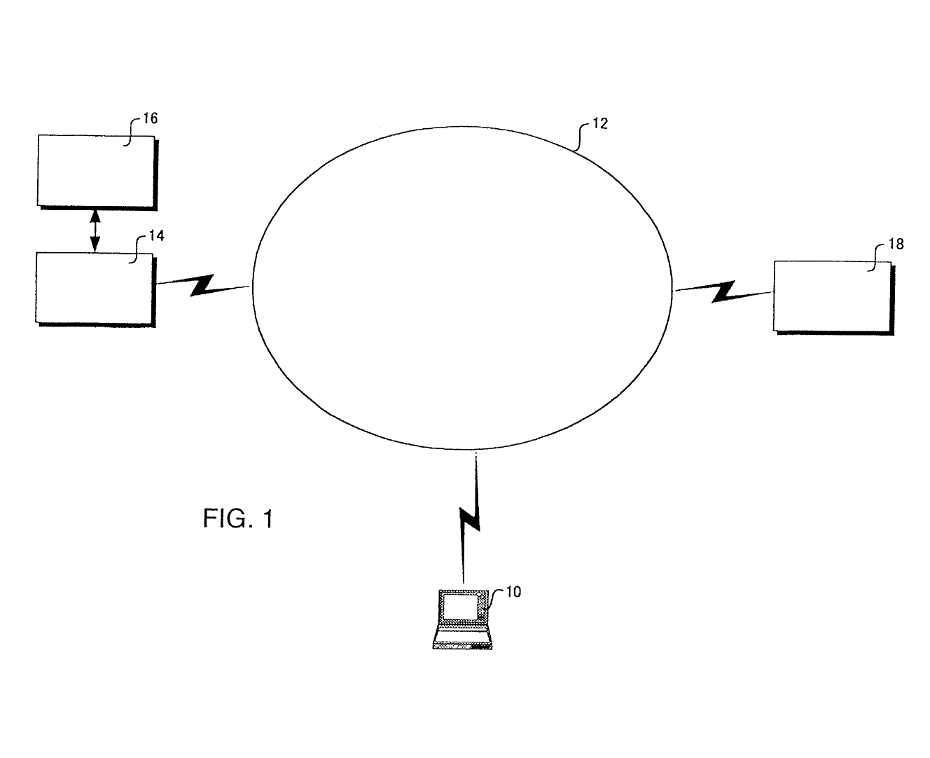

One embodiment of the present invention is described below with reference to the drawings. FIG. 1 shows an overall schematic diagram for implementing the present invention. Recently, various home pages (including those based on the i-mode service provided by NTT DoCoMo of Japan) are operated over the Internet, both wireline and wireless, among which there are many home pages intended to sell goods online. From various home pages provided over the Internet 12, a person who wants to buy a book uses a computer 10 to select and browse a home page where books are sold online. For example, if a home page that deals with Internet shopping is stored in a server 14, then the would-be customer makes access from the computer 10 to the home page stored in the server 14 via the Internet 12. The home page presents available books in list form, for example, and the would-be customer select a desired book from the list. If he wants to know more about the content of the book, he may gain more detail of the book by clicking the “Detail” button placed on the home page. If he wants to read that content thoroughly, he may download it into his own computer for reading at leisure. The detailed content of the book may be stored within the server 14 or stored in a mass storage 16 connected to the server 14.

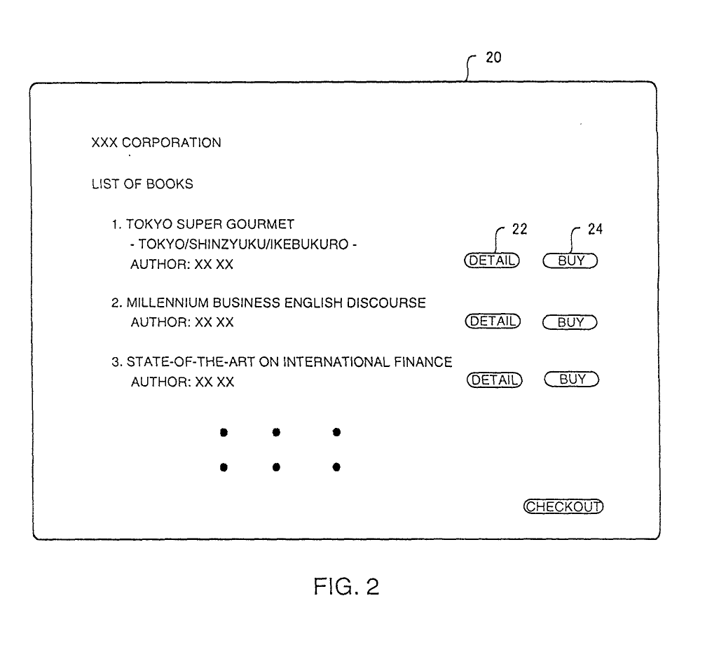

FIG. 2 shows an example of a home page 20 where books to be sold are presented in list view. Titles of books available are enumerated in list form, with a “Detail” button 22 for viewing the detail of the book placed on the right side thereto, and a “Buy” button 24 to buy the book also placed on the right side thereto. To proceed to the checkout after selecting the book to be purchased, the “Checkout” button located in the lower right corner of the screen may be clicked to go to the checkout screen.

The detail of the book is displayed by clicking the “Detail” button 22, although a portion of the content of the book is presented. The amount of the content displayed may be varied anyway, depending on the book; for example, about one-fourth, one-third, or half the content may be posted, or, in some cases, the entire text may also be presented for viewing. In other words, from the standpoint of a would-be customer, the same situation where he physically browses the book at the bookstore is realized on the computer. Thus, the entire book may be ascertained from the content displayed on screen. This can motivate the potential customer to buy the book.

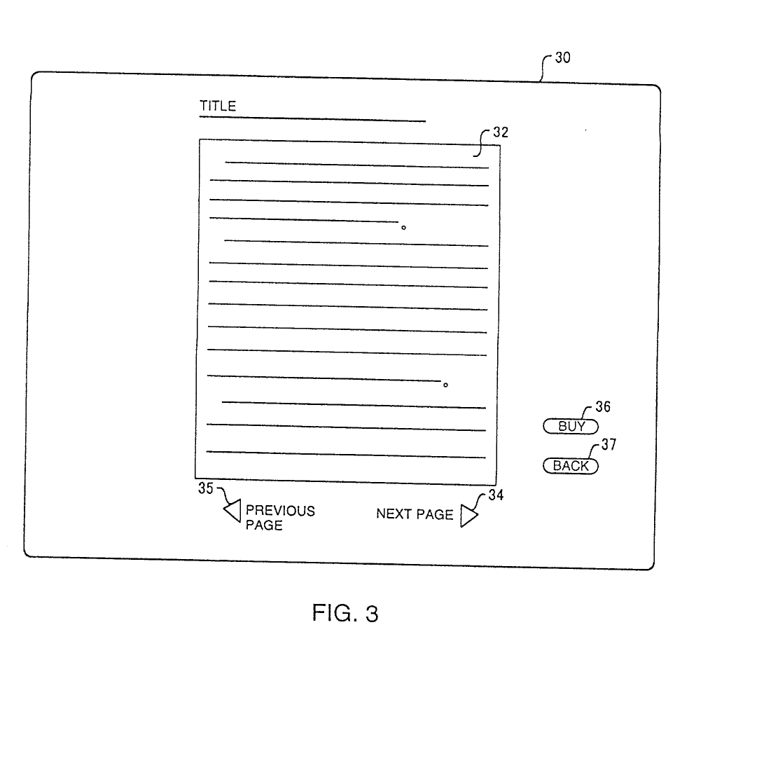

FIG. 3 shows an example of a screen 30 where the content of a book is displayed. The data displayed may be sent as a PDF (portable document format) file, although it may also be sent in other formats. The content 32 of the book may contain not only text information but also graphics and images. By clicking a “Next Page” button 34 or “Previous Page” button 35, one can move to a desired page. If the would-be customer decides to buy while browsing, he may click the “Buy” button 36, whereby the book is put in the shopping cart, and then returns to the initial screen shown in FIG. 2. If he does not want to buy, he may click the “Back” button 37 to go back to the screen shown in FIG. 2.

If the would-be customer has ascertained the content of the book and further wants a hardcopy thereof, that is, wants to buy the book, he may click the “Buy” button 24 placed on the home page, whereby the book is put in the shopping cart. If he wants to read another book, he may just repeat the same process as described above.

Eventually, once the book(s) to be purchased has been decided, the checkout process is initiated by clicking the “Checkout” button. This process, which may be the same as used in typical Internet shopping, is basically executed by inputting the address to which the good is delivered and payment method. More specifically, the address and name to which the book is delivered are inputted, as well as the credit company name, credit number, and expiration date of the credit card, if credit card payment is selected as the payment method. Other payment methods, such as “cash on delivery” where the customer pays cash upon receipt of the book, may also be selected.

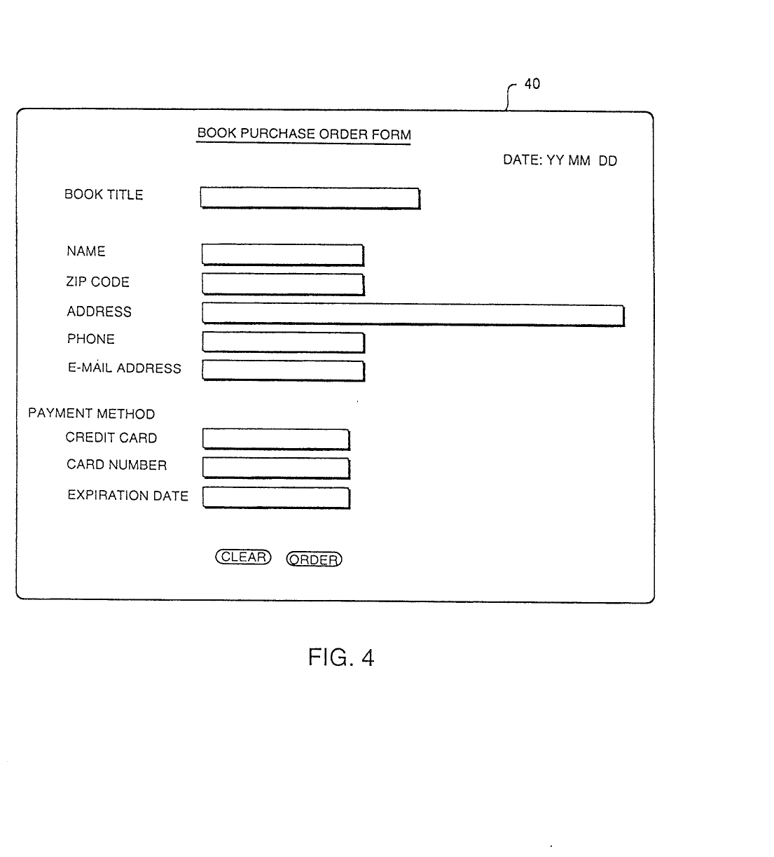

FIG. 4 shows an example of a page 40 where the above purchase procedure is performed. By inputting the name of the buyer, address to which the book is delivered, and so forth, as well as the credit card number and so forth, a payment method is specified. By clicking the “Order” button after the predetermined items have been inputted, a book purchase order is finally completed.

As described above, when the book purchasing procedure (checkout) is completed, the information regarding the book title and the address to which the book is delivered is routed to a book printing vendor via the Internet. Such information may be sent to a computer 18 of the book printing/binding vendor. Upon receipt of the print request, the vendor starts printing in accordance with a predetermined format from the electronic information of the book obtained beforehand. The printed book is delivered to the book buyer by mail, home delivery service, etc.

The above purchase procedure may be processed on the book recommendation home page that recommends books, although it may also be processed on a home page of a book printing vendor. In that case, once the purchase of a book is decided, it jumps from the book recommendation home page to the home page of the book printing/binding vendor linked thereto, where the above-described book purchase procedure is performed.

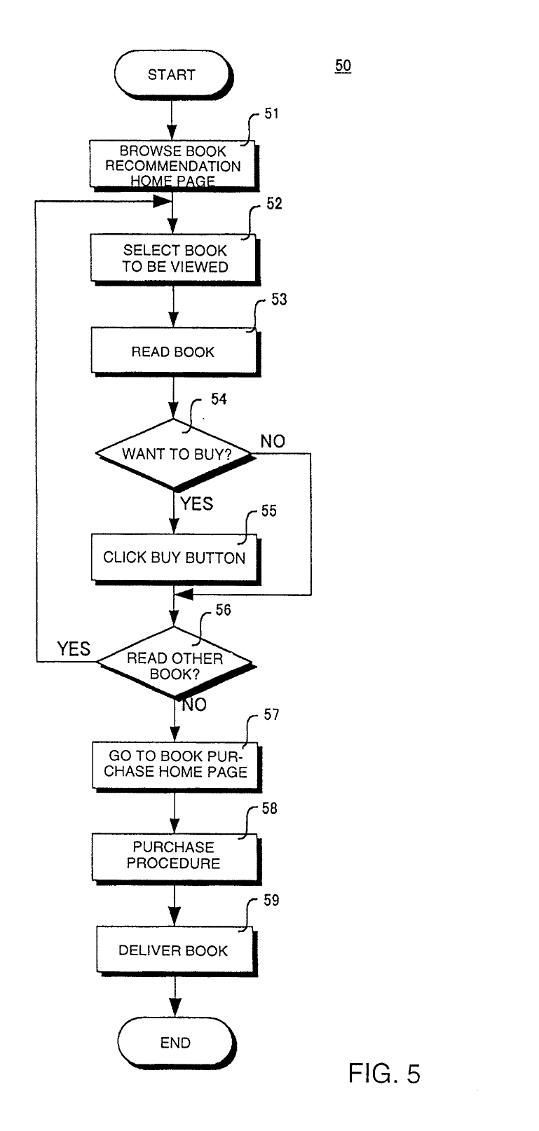

Next, the method of the present invention is described in greater detail in accordance with the flowchart 50 shown in FIG. 5. First, at block 51, a person who wants to buy a book opens the book recommendation home page that recommends books, and browses the book list presented. Proceeding to block 52, the 12 would-be customer selects a book from the book list to view its detail, and clicks the “Detail” button. When the “Detail” button is clicked, the process proceeds to block 53, where the detail information on the book selected is displayed on the computer screen. The detail information discloses a portion, i.e., at least half, of the content of the book, or, in some cases, the whole content thereof. The would-be customer may then read the content of the book displayed.

It is determined, at block 54, whether a hard copy of the book is needed after reading the content of the book. If a hard copy is desired, the book is placed in the shopping cart by clicking the “Buy” button located on the screen. If he does not want to purchase it, the process proceeds to block 56. At block 56, it is determined whether he desires to read any additional book. If desired, the process returns to block 52, where the procedure described above is repeated. If not desired, the process proceeds to block 57, where the book purchase procedure (checkout) is initiated.

At block 57, the browser goes to the page where a procedural process for book purchase is performed. For this page, the browser may go to another page in the book recommendation home page, although it may also move to the book purchase home page of the printing vendor linked from the book recommendation home page. Once the browser moves to the book purchase home page, the name and address that identify the customer are inputted, and the payment method is specified as described above. Once those bibliographic items have been inputted at block 58, such information is sent to the book recommending vendor and/or printing/binding vendor via the Internet, so that production of a book hard copy is initiated. Once the book has been produced, it is delivered to the customer by mail or home delivery service (block 59).

In summary, according to the present invention, the content of the book is disclosed via the Internet to a degree that allows the reader to know it sufficiently, and thus motivates him to buy the book. The content of the book is viewable at least in half, or, in some cases, as a whole, so that the same situation associated with physically browsing books at the bookstore is realized over the Internet.

Furthermore, because the content of the book is stored as electronic information in a storage device and book printing and binding is initiated in response to a request from a book buyer, there are advantages, among others, that books left unsold due to anticipatory production are not wasted, and the need for book-showcasing space is eliminated.

1. An on-demand book purchasing method, wherein a book is printed and delivered via a telecommunication line in response to a request from a person who wants to buy the book, said method comprising the steps of:
displaying a list of books on a book recommendation home page;
selecting a book from said book list in response to a request from said person who wants to buy the book, and displaying a portion of the content of the book selected;
when the person wants to buy the book selected, inputting predetermined items required to buy said book.

2. An on-demand book purchasing method according to claim 1, wherein said step of displaying a portion of the content of the book comprises the step of displaying the content of the book selected corresponding to at least half the pages or text characters thereof.

3. An on-demand book purchasing method according to claim 1, wherein said step of displaying a portion of the content of the book comprises the step of displaying the entire content of said book selected.

4. An on-demand book purchasing method according to claim 1, wherein said step of inputting predetermined items includes the step of going to a home page of a printing or book binding vendor that is linked to said book recommendation home page.

5. An on-demand book purchasing method according to claim 1, wherein said step of inputting predetermined items required to buy said book includes the step of inputting items that specify the name and address of the person who buys the book, and payment method.
